(19) United States
(12) Patent Application Publication
(10) Pub. No.: US 2026/0152012 A1
(43) Pub. Date: Jun. 4, 2026

(54) DRYING INK AND COOLING MEDIA FOR INKJET SYSTEMS

(71) Applicant: Xerox Corporation, Norwalk, CT (US)

(72) Inventors: Erwin RUIZ, Rochester, NY (US); Nicolas C. PIETRANTONI, Webster, NY (US); Palghat S. RAMESH, Pittsford, NY (US); Megan ZIELENSKI, Holland Patent, NY (US); Samuel E. KUHL, Williamson, NY (US)

(21) Appl. No.: 18/967,185

(22) Filed: Dec. 3, 2024

(51) Int. Cl. B41J 11/00; B41J 29/377

(52) U.S. Cl. CPC B41J 11/0022; B41J 29/377

(57) ABSTRACT

Exemplary aspects include heating the media and drying the ink by forced convection generated from a Coanda heater. By providing and heated air flow over a curved surface, a low pressure Bernoulli effect will acquired the media to glide over the heated forced air. Similarly, by providing a cold air over a curved surface, the media will be acquired by the same low pressure principle. The cold air will cool down the media by forced convection. Direct forced air is an efficient way to heat or cool the media. An upper flow on top of the media will facilitate the removal of the evaporated ink water and solvent. The solvent could be captured by a filter. Air heaters are significantly cheaper than infrared lamps and more robust.

### FIELD OF DISCLOSURE

The present disclosure relates to paper handling during paper path transport within an imaging system, and more particularly, to an approach to drying ink and cooling media using the Coanda Principles for inkjet systems.

### BACKGROUND

Inkjet systems including inkjet imaging systems and inkjet digital print presses deposit direct ink (e.g., aqueous, ultra-violet (UV), CMYK) onto print media, where the ink may be dried by heating the media with infrared (IR) lamps configured to dry and/or cure the ink. A plurality of IR lamps may be used in drying systems used in inkjet systems. Unfortunately, drying systems with IR lamps are costly and take up a large amount of space, for example, the size of an entire print engine in an inkjet system. For inkjet systems that add a cooling stage, the size of a drying system and cooling module can take up at least 25-30% of the machine footprint.

Current IR lamp drying capacity limits printing output and print media weight. In known systems, drying capacity maxes out at about 250 gsm coated stock at 58 kHz speed. To accommodate increasing print speeds (e.g., up to and including 77 kHz) and higher media weights (e.g., up to 350 gsm coated stock) in the future, the lamp power must increase in the current dryer design, which adds significant cost. The design of drying systems is often predicated on the age old paradigm of temperature and time. At a given temperature, drying can be improved by increasing dwell time, i.e. increasing the footprint of the dryers. Conversely for given dwell time (i.e. dryer foot print), drying can be improved by increasing the temperature (more power density). Both of these choices add cost and complexity.

Xerographic and inkjet digital presses include media handling configurations that have to contend with sections of a paper path where the media sheet is unsupported during transition between sheet transports (e.g., marking transports, downstream media processing) and affected by process speed, up curl and down curl, sheet stiffness, etc. These can further be influenced by humidity, ink placement, toner/ink amount, grain direction, paper weights, etc. Controlling the sheet trajectory and processing may become more difficult in areas where it is prohibited to touch the top surface of the sheet with conventional devices, such as, nip rollers and baffles, as in the case of transporting pre-fused or pre-dried images.

Obviously, there is a need for a more efficient ink drying system that will work with future designs. Further, there is still a need for an improvement in managing sheet processing in xerographic and inkjet imaging systems.

### SUMMARY

The following presents a simplified summary in order to provide a basic understanding of some aspects of one or more embodiments or examples of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later. Additional goals and advantages will become more evident in the description of the figures, the detailed description of the disclosure, and the claims.

The foregoing and/or other aspects and utilities embodied in the present disclosure may be achieved by providing media sheet transport system including a drying apparatus for drying marking material deposited on media conveyed along a paper path between first and second media transports configured for conveying the media in a media processing direction. The system includes a curved baffle, a lower hot air flow device, and a vapor removal device. The curved baffle is positioned between the first and second media transports. The lower hot air flow device is positioned adjacent the curved baffle and under the paper path of the media conveyed between the first and second media transports. The vapor removal device is positioned above the lower hot air flow device and above the paper path of the media conveyed between the first and second media transports. The lower hot air flow device is configured to apply a layer of uniform high velocity heated air that travels around the curved baffle and under the media to heat the media and dry the marking material deposited thereon while diverting the media towards the curved baffle. The vapor removal device is configured to apply an airflow towards and then away from the media for removal vapor from the media.

According to aspects illustrated herein, an exemplary method for drying marking material deposited on media conveyed along a paper path between first and second media transports configured for conveying the media in a media processing direction includes: applying a layer of uniform high-velocity heated air around a curved baffle positioned between the first and second media transports, the layer of high-velocity heated air supplied from a lower hot air flow device positioned adjacent the curved baffle and under the paper path of the media as it is conveyed between the first and second media transports, the layer of high-velocity heated air travelling around the curved baffle and under the media; heating the media with the layer of high-velocity heated air to dry the marking material deposited thereon while diverting the media towards the curved baffle and the second media transport; and applying an airflow from a vapor removal device towards and then away from the media to remove vapor from the media, the vapor removal device positioned above the paper path of the media as it is conveyed between the first and second media transports.

According to aspects described herein, an exemplary apparatus for drying marking material deposited on media conveyed in a paper path between first and second media transports configured for conveying the media in a media processing direction includes a curved baffle, a lower hot air flow device, a vapor removal device. The curved baffle is positioned between the first and second media transports. The lower hot air flow device is positioned adjacent the curved baffle and under the paper path of the media conveyed between the first and second media transports. The lower hot air flow device is configured to apply a layer of uniform high velocity heated air. The vapor removal device is positioned above the lower hot air flow device and above the paper path of the media conveyed between the first and second media transports. The vapor removal device includes an upper air flow device configured to apply an airflow at a velocity lower than the layer of high velocity heated air above the media. The lower hot air flow device is configured to apply the layer of high velocity heated air that travels around the curved baffle and under the media to heat the media and dry the marking material deposited thereon while diverting the media towards the curved baffle. The vapor removal device is configured to apply the airflow from the upper air flow device towards and then away from the media for removal of solvents including the vapor from the media.

Exemplary embodiments are described herein. It is envisioned, however, that any system that incorporates features of apparatus and systems described herein are encompassed by the scope and spirit of the exemplary embodiments.

### BRIEF DESCRIPTION OF THE DRAWINGS

Various exemplary embodiments of the disclosed apparatuses, mechanisms and methods will be described, in detail, with reference to the following drawings, in which like referenced numerals designate similar or identical elements, and:

FIG. 1 is a side view partially in section of an exemplary media sheet ink drying apparatus according to systems and methods describe herein;

FIG. 2 is a partial side view of the media sheet ink drying apparatus of FIG. 1;

FIG. 3 is a side view partially in section of a media sheet transport system according to systems and methods describe herein;

FIG. 4 is a partial side view of the media sheet cooling apparatus of FIG. 3;

FIG. 5 is a side view partially in section of another media sheet transport system according to systems and methods describe herein;

FIG. 6 is a block diagram of a controller for executing instructions to control the media sheet transport system; and

FIG. 7 is a flowchart depicting the operation of an exemplary media sheet transport system

### DETAILED DESCRIPTION

Illustrative examples of the devices, systems, and methods disclosed herein are provided below. An embodiment of the devices, systems, and methods may include any one or more, and any combination of, the examples described below. This invention may, however, be embodied in many different forms and should not be construed as limited to the embodiments set forth below. Rather, these exemplary embodiments are provided so that this disclosure will be thorough and complete, and will fully convey the scope of the invention to those skilled in the art. Accordingly, the exemplary embodiments are intended to cover all alternatives, modifications, and equivalents as may be included within the spirit and scope of the apparatuses, mechanisms and methods as described herein.

We initially point out that descriptions of well-known starting materials, processing techniques, components, equipment and other well-known details may merely be summarized or are omitted so as not to unnecessarily obscure the details of the present disclosure. Thus, where details are otherwise well known, we leave it to the application of the present disclosure to suggest or dictate choices relating to those details. The drawings depict various examples related to embodiments of illustrative methods, apparatuses, and systems for automatically collecting, collating and transporting media strips (e.g., workpieces, retail edge marker strips) destined for in-store shelves.

When referring to any numerical range of values herein, such ranges are understood to include each and every number and/or fraction between the stated range minimum and maximum. For example, a range of 0.5-6% would expressly include the endpoints 0.5% and 6%, plus all intermediate values of 0.6%, 0.7%, and 0.9%, all the way up to and including 5.95%, 5.97%, and 5.99%. The same applies to each other numerical property and/or elemental range set forth herein, unless the context clearly dictates otherwise.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.”

The terms “media”, “print media”, “print substrate” and “print sheet” generally refers to a usually flexible physical sheet of paper, polymer, Mylar material, plastic, or other suitable physical print media substrate, sheets, webs, etc., for images, whether precut or web fed. The listed terms “media”, “print media”, “print substrate” and “print sheet” may also include woven fabrics, non-woven fabrics, metal films, and foils, as readily understood by a skilled artisan.

The term ‘image forming device”, “printing device” or “printer” as used herein encompasses any apparatus that performs a print outputting function for any purpose, such as a digital copier, scanner, image printing machine, xerographic device, digital production press, document processing system, image reproduction machine, bookmaking machine, facsimile machine, multi-function machine, or the like and can include several marking engines, feed mechanism, scanning assembly as well as other print media processing units, such as paper feeders, finishers, and the like. An image forming device can handle sheets, webs, marking materials, and the like. An image forming device can place marks (e.g., marking material) on any surface, and the like and is any machine that reads marks on input sheets; or any combination of such machines. It will be understood that the structures depicted in the figures may include additional features not depicted for simplicity, while depicted structures may be removed or modified.

The term “marking material” as used herein may refer to printing matter deposited by an image forming device onto a substrate to form an image on the substrate. The listed term “marking material” may include inks, toners, metal particles, plastics, pigments, powders, molten materials, polyamide, nylon, glass filled polyamide, epoxy resins, bio-based resins, wax, graphite, graphene, carbon fiber, photopolymers, polycarbonate, polyethylene, Polylactic acid (PLA), Polyvinyl alcohol (PVA), ABS filament, high-density polyethylene (HDPE), high impact polystyrene (HIPS), Polyethylene terephthalate (PETT), ceramics, conductive filament and other ink jet materials.

The term “controller” or “control system” is used herein generally to describe various apparatus such as a computing device relating to the operation of one or more device that directs or regulates a process or machine. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

Although embodiments of the invention are not limited in this regard, discussions utilizing terms such as, for example, “processing,” “computing,” “calculating,” “determining,” “using,” “establishing”, “analyzing”, “checking”, or the like, may refer to operation(s) and/or process(es) of a controller, computer, computing platform, computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

A system is disclosed that efficiently dries ink on constrained and unsupported media by forced convection generated from a Coanda heater during a transition between media transports upstream and downstream the heating. The system includes placing a curved baffle between adjacent paper path transports and applying a thin layer of high velocity uniform air flow over the curved baffle's surface to constrain the media sheet. The thin layer of high velocity uniform air flow over the curved surface of the baffle will have a tendency to follow the curved baffle (Coanda effect) and divert the sheet (Bernoulli effect) towards the baffle. By positioning a curved baffle along the media path and by applying a high velocity uniform air stream to it, a lower pressure area will be created. This will flatten the sheet's trajectory so that the sheet will be reliably received by a downstream vacuum or electrostatic transport.

By providing and heated air flow over a curved surface, a low pressure Bernoulli effect acquires the media to glide over the heated forced air. Similarly, by providing a cold air over a curved surface, the media will be acquired by the same low pressure principle. The cold air will cool down the media by forced convection. Direct forced air is an efficient way to heat or cool the media. An upper flow on top of the media may facilitate the removal of undesired substance (e.g., evaporated ink water, vapor, solvent) from the media environment. The solvent may be captured by a filter. In examples, forced air may be heated air (e.g., above 110° C., above 100° C., above 50° C., above the printer internal ambient temperature) for drying or a cold air (e.g., below 40° C., below the printer internal ambient temperature) for cooling down media.

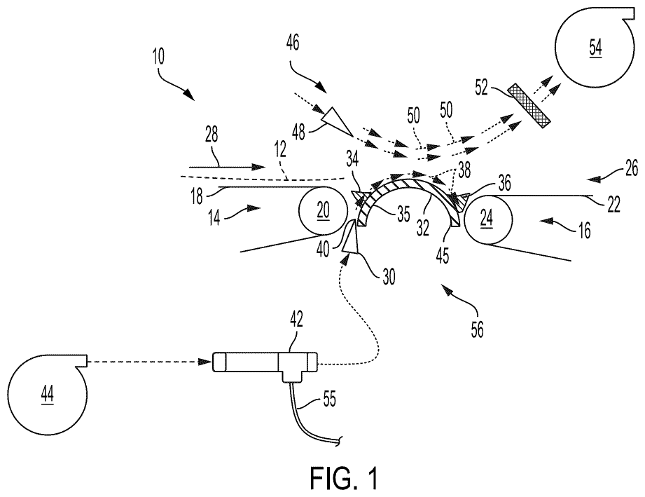

FIG. 1 depicts an exemplary media sheet transport system 10 having a media sheet ink drying apparatus 56 useable within or after an imaging system. The system 10 includes a media sheet 12 on a first transport 14 (e.g., marking transport, tray with moving member, structure designed to convey media or media sheets) conveyed towards a second transport 16 (e.g., media transport, Coanda station, additional marking transport, media sheet tray, structure designed to receive media or media sheets). The media sheet 12 may be conveyed over the first transport 14 having a belt 18 entrained around a roller 20 and may further be conveyed over the second transport 16 having another belt 22 entrained around another roller 24. Both belts 18, 22 may be stretch around additional rollers (not shown) to remain taut during use.

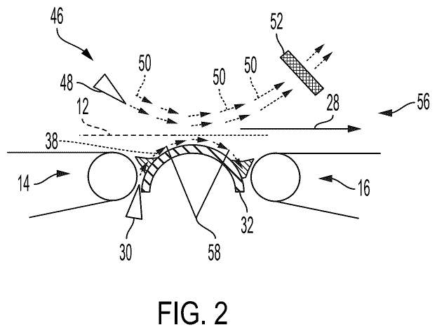

The media sheet transport system 10 includes a media handling apparatus 26 that may use Coanda and Bernoulli effects to aid in controlling media sheet 12 heating, cooling, transporting and marking material curing on the media sheets between the first and second transports 14, 16. In FIG. 1, a media sheet 12 is shown conveyed in a media processing direction of arrow 28 via use of an air knife 30, a curved baffle 32 and entrance and exit ribs 34, 36 thereof, respectively. This is accomplished by creating a thin layer of uniform high velocity air (e.g., at least 40 m/s, at least about 50 m/s, about 60 m/s to 160 m/s) in the direction of arrows 38 from nozzle 40 of the air knife 30 that flows over the curved baffle 32 and under sheet 12. The air velocity drops as the thin layer of high velocity air flows and expands in the direction of the arrows 38, over the curve baffle 32. For example, the air velocity may drop to about 0.5-30 m/s, or to about 1.5-15.0 m/s as the air approaches a rear falling side 45 or exit ribs 36 of the curved baffle, or a back side of a heating “dwell time” zone 58 (FIG. 2) over the curved baffle. Control of the high velocity air flow can be defined and modified based upon the media sheet type and weight, with greater air flow typically needed as media weight increases. Further, in examples, the air knife 30 may have an inlet pressure of between about 2-100 psi, or 5-75 psi, or 10 psi-40 psi that it converts into the thin layer of high velocity air.

The high velocity layer of air, which will have a tendency to follow the curved baffle 32 (Coanda effect), diverts the media sheet 12 (Bernoulli effect) towards and around the curved baffle, with the layer of air flowing along arrows 38 maintaining an air bearing so media sheets do not touch the baffle. By positioning the curved baffle along the media paper path between the transports 14, 16 and by applying a uniform air stream to it, the air will follow the curved surface of baffle 32 and media sheet 12 will follow. In addition, entrance ribs 34 may include openings therein to provide a boundary condition for down-curled media at a front rising side 35 of the curved baffle 32, while simultaneously allowing air flow to pass between the ribs to enhance initial acquiring of the media sheet. Exit ribs 36 may provide a boundary condition for media sheets that may curl down at the rear falling side 45 of the curved baffle, while simultaneously providing a trajectory during hand-off of the media sheet to the second transport 16. The components depicted in FIG. 1 may be part of a media sheet ink drying apparatus 56, as will be further described in greater detail below.

The thin layer of uniform high velocity air from the air knife 30 may be hot air (e.g., above 110° C., above 100° C., above 50° C., above the printer internal ambient temperature) for drying wet marking material on media sheets 12 by forced convection. By providing a heated air flow over a curved surface of the curved baffle 32, a low-pressure Bernoulli effect acquires the media sheets to glide over the heated forced air. This high temperature air flow heats the media sheets gliding over the curved surface. The air flow acts as a convection heater and as an air bearing that floats the media sheet toward the downstream second transport 16. Heating the media sheets helps the evaporation process that dries the marking material. Because the heated airflow 38 is underneath the media sheets opposite the wet marking material, the image is not disturbed. This enables the media sheet ink drying apparatus 56 to increase air flow and maximize heat transfer capacity.

The high velocity hot air may be sourced from a hot air supply 42 (e.g., air process heater, t-type heat pipe, heat pipe, IR heaters) used for in-line air/gas heating to heat ambient air. The hot air supply 42 may be coupled to an electrical power source (not shown) such as a battery or power outlet via conductive line 55 and heat air exiting a cool or ambient air source 44 (e.g., compressed air supply, blower). In examples, the hot air is hotter than the surrounding ambient temperature, and sufficiently hot to help dry and/or cure marking material on the media sheet 12. For example, the hot air may be well-above 100° C. to heat the media sheet 12 and marking material thereon. In certain examples, the hot air is above about 300° C. up to at least 540° C., as understood by a skilled artisan, and heats the media sheet 12 to a temperature of at least about 110° C. to help cure wet marking material on the media sheet. Velocity and temperature of the high velocity heated air blowing from the air knife 30 may be based on variables such as media sheet weight, ink weight and viscosity, printer speed, media sheet transport speed, etc., as well understood by a skilled artisan.

The media sheet ink drying apparatus 56 also includes a vapor removal device 46 positioned above the paper path of the media sheet 12 conveyed between the first and second media transports 14, 16 to remove undesired substance (e.g., evaporated ink water, vapor, solvent) from the media sheet 12 caused by media sheet heating. Such undesired substance may be generated from evaporation of volatile components in the marking material on the media sheet 12, including water and cosolvents. As can be seen in FIG. 1, the vapor removal device 46 may include an upper air flow device 48 such as an upper air flow air knife, fan or air outlet that applies an upper airflow along direction arrows 50 above the media sheets 12 for removal of solvents including vapor from the media sheets caused primarily by heating the media sheet by the hot air supply 42 and air knife 30. While not being limited to a particular theory, the airflow from the upper air flow device 48 flows along the direction arrows 50 at a velocity low enough to facilitate removal of solvents, and to not disturb or move the marking material on the media sheets, as any marking material movement or running on the media sheets would degrade print quality.

In examples, the upper airflow from the upper air flow device 48 is lower than the high velocity heated air blowing from the air knife 30, as higher velocity heated air below the media sheets heats and moves media sheets across the curved baffle. The high velocity heated air flowing from below the media sheets 12 is faster to keep the media sheets close to the curved surface of the baffle 32, and also heats the media sheets from below with marking material on top of the media sheets. Further, the higher velocity heated air flows along the media sheets from below the sheets opposite the marking material on the top side of the media sheets, and thus does not degrade print quality. In some examples, the upper airflow from the upper air flow device 48 is heated air (e.g., air process heater, t-type heat pipe, heat pipe, IR heaters) hotter than a temperature of the ambient air within the image forming device to help heat and removes solvents from the media sheet. Such solvents may include ink solvents, water, dust, and other solvents having high boiling temperatures of at least 200° C.

The vapor removal device 46 may also include a solvent filter/collector 52 downstream the upper air flow device 48 in the media processing direction, with the filter/collector configured to collect the solvents from the media sheet removed via the heating of the media sheets and the upper air flow device. The system may also include an exit blower 54 or fan that blows the solvent and vapor away from media handling apparatus 26 and media sheets thereon.

FIG. 2 depicts the media sheet ink drying apparatus 56 of FIG. 1, which may be part of a larger imaging system or a standalone drying system. As the media sheet 12 is conveyed from the first transport 14, the air knife 30 applies a layer of high velocity uniform heated air that flows along direction arrows 38 around the curved baffle 32 (Coanda effect) and pulls the media sheet over the heated forced air to the second transport 16. Media sheet temperature increases (e.g., to at least about 110° C.) due to the hot air flow, in particular over the heating “dwell time” zone 58, causing solvent evaporation. Heated upper airflow from the upper air flow device 48 along the direction arrows 50 assist in the removal of the evaporated water and solvent, which may be captured by the solvent filter 52 and/or expelled from the area by an exit blower 54 (FIG. 1).

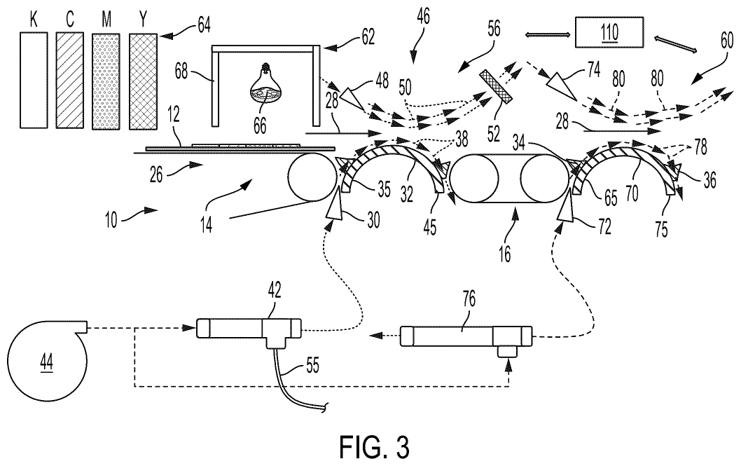

FIG. 3 depicts the media sheet transport system 10 having the media sheet ink drying apparatus 56, a media sheet cooling apparatus 60 and a pre-heat station 62. The pre-heat station 62 is located above the media handling apparatus 26 downstream an imaging station including print heads 64, and upstream the vapor removal device 46 in the media processing direction 28. The preheat station 62 may include a heating device 66 (e.g., heat bulb, diodes, air heater, IR heater) configured to heat media sheets 12 prior to its conveyance to the curved baffle 32. The heating device 66 may be partially enclosed by housing walls 68 that may help direct heat from the heating device to media sheets 12 below. In examples, the walls 68 may be solid and include vent ports (not shown) for air to circulate into and out of the pre-heat station 62. Preheating provided by the preheat station 62 helps to pin/cure marking material images to the media sheets before drying/curing at the media sheet ink drying apparatus 56.

The media sheet cooling apparatus 60 is located downstream the media sheet ink drying apparatus 56 in the media processing direction 28, and may cool heated media sheets 12 exiting the media sheet ink drying apparatus and either before the heated media sheets exit an image forming device housing the media sheet transport system 10 or before imaging on a second side of the heated media sheets. In examples, the cooling apparatus 60 includes a second curved baffle 70, a lower cold air flow device 72 (e.g., air knife) and an upper cold air flow device 74 (e.g., air knife, fan, forced air outlet). The second curved baffle 70 is positioned downstream the second media transport 16 and has a front rising side 65 adjacent the second media transport and a rear falling side 75 downstream the front rising side. The second curved baffle may also include entrance ribs 34 at the front rising side 65, and exit ribs 36 at the rear falling side 75.

The lower cold air flow device 72 is positioned adjacent the second curved baffle 70 and under heated media sheets 12 conveyed from the second media transport 16. In examples, the lower cold air flow device 72 emits and/or directs air towards heated media sheets to cool the sheets to a cooler temperature (e.g., under 60° C., less than 50° C., about 30°C-40°C) for further processing or handling of the sheets. The lower cold air device 72 may be coupled to a cold air supply 76 (e.g., vortex cooling tube, refrigerated compress air outlet, blower or compressed air source 44) and applies a uniform flow or layer of high velocity cold air (e.g., at least 40 m/s, at least about 40m/s, about 60 m/s to 160 m/s) that is colder that the high velocity heated air discussed above and cooler than ambient air around the media sheet transport system 10 and within an enclosing image forming device. The cold air supply 76 may output cold air at temperatures of, for example, less than about 40° C., or less than about 25° C., or about −34° C. to 21° C. The cold air may be adjusted to cool the media sheets 12 to the cooler temperature of about less than 80° C., or 10° C.-70° C., or about 30° C.-60° C. as understood by a skilled artisan. The layer of high velocity uniform cold air flows along direction arrows 78 around the second curved baffle 70 and cools heated media sheets while moving the sheets about the second curved baffle 70, as will be discussed in greater detail below.

The upper cold air flow device 74 (e.g., air knife, air flow outlet) may be positioned above the lower cold air flow device 72 and above media sheets 12 conveyed from the second media transport 16. While not being limited to a particular theory, the upper cold air flow device may apply an upper airflow, for example, along direction arrows 80, above heated media sheets conveyed along media processing direction arrow 28 above the second curved baffle 70 to help remove heat from the sheets. In examples, the upper cold air flow device 74 may emit and/or direct a uniform layer or flow of air from an air supply (e.g., air source 44) that is colder than the high velocity heated air discussed above, and that is also at a velocity lower than the high velocity air above the media to further cool the media sheet top surface while avoiding potential media sheet lifting from the Coanda curved surface of the second curved baffle 70. The air source 44 may blow air colder than the heated air discussed above, and cooler than the ambient temperature to at least the hot air supply 42, the cold air supply, the lower cold air flow device 72, or the upper cold air flow device 74, as is readily understood by a skilled artisan. Airflow from the upper cold air flow device 74 may flow along direction arrows 80 at a velocity low enough to facilitate removal of heat from media sheets 12, and to not disturb or move the marking material on the media sheets, as any marking material movement or running on the media sheets would degrade print quality.

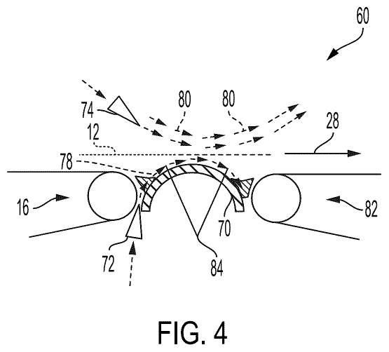

FIG. 4 depicts the media sheet cooling apparatus 60 of FIG. 3, which may be part of a larger imaging system or a standalone cooling system. As the heated media sheet 12 is conveyed from the second transport 16, the lower cold air flow device 72 directs a uniform layer of high velocity cold air that flows along direction arrows 78 around the second curved baffle 70 (Coanda effect) and pulls the media sheet over the cold forced air in the media processing direction of arrow 28 to a downstream media handling device 82 (e.g., additional transport, baffle, output tray, Coanda station, additional marking transport, structure designed to receive media or media sheets). The media sheet 12 is acquired by the lower pressure created by the air flow that is in between the media sheet and the top surface of the second curved baffle 70. The air flow acts as a convection cooler and as an air bearing that floats the media sheet toward the downstream media handling device 82. Media sheet temperature decreases (e.g., to at most about 40° C.) due to forced convection caused by the cold air flow, in particular over the cooling “dwell time” zone 84, which also cools any marking material on the media sheet. Chilled upper airflow from the upper cold air flow device 74 along the direction arrows 80 assist in lowering the media sheet 12 top surface and marking material temperature.

It should be noted that in examples, the second transport 16 may also be referred to as an upstream transport, in that it is a transport upstream the media sheet cooling apparatus 60. In certain examples where the cooling apparatus 60 is used as a standalone device absent or away from an ink drying apparatus 56 or other media sheet heating device, the upstream transport before the cooling apparatus 60 may be considered a “first” transport.

The media sheet transport system 10 depicted in FIG. 3 combines techniques of drying wet marking material on media sheets 12 and cooling the media sheets using the Coanda principle. Evaporation rate of ink liquid in the marking material may be determined by the vapor pressure at the liquid surface and the rate of diffusion of vapor through the air above the liquid. The vapor pressure is a function of the temperature of liquid. The diffusion rate is typically limited by a boundary layer that forms above the liquid surface. This boundary layer of vapor may be facilitated by air flow that moves the vapor for increased evaporation. Thus, external air flow from the upper air flow device 48 (e.g., air knife) may be used in examples to help increase the rate of ink vapor diffusion through the boundary layer. This may bring a challenge of increasing airflow near the marking material liquid surface of media sheets 12 without disturbing the image thereon.

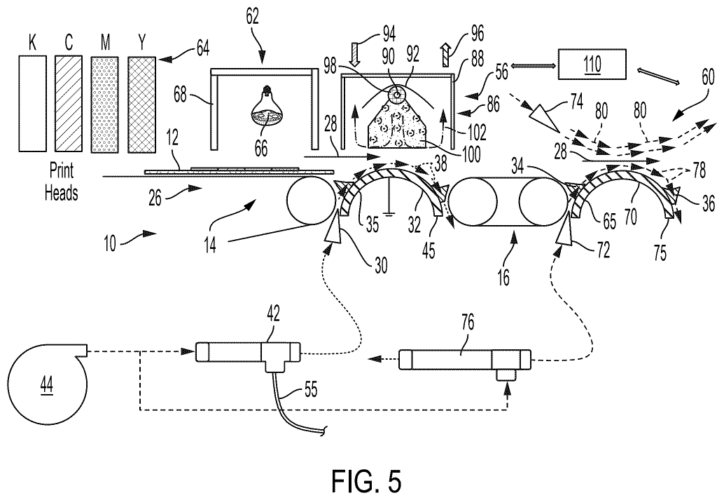

FIG. 5 depicts another example of a media sheet transport system 10 having the media sheet ink drying apparatus 56, the media sheet cooling apparatus 60 and the pre-heat station 62. In the example illustrated in FIG. 5, the media sheet ink drying apparatus 56 add a corona wind concept, to further improve drying efficiency via a corona wind module 86. The corona wind module 86 is positioned as the vapor removal device 46 above the paper path of media sheets 12 conveyed between the first and second media transports 14, 16 to remove undesired substance (e.g., evaporated ink water, vapor, solvent) from the media sheet 12 caused by media sheet heating.

While not being limited to a particular configuration, the corona wind module 86 may include a housing shell 88 that partially encloses a corona wire 90 and conductive shield 92. In examples, the shell 88 may be solid and include vent ports (not shown) for air to circulate into (e.g., exhaust air in 94) and out (e.g., exhaust air out 96) of the corona wind module 86. The conductive shield 92 is metal or conductive and may be grounded. The Coanda curved baffle 32 underneath media sheet 12 is electrically conducting and grounded. It should be noted that, as with all of the drawings discussed herein, the arrangement of structure shown in the drawings is not limited to scale or spacing. For example, the distance between the corona wire 90 and media sheets 12 may be smaller than the distance between the wire and the conductive shield 92.

The corona wire 90 is a high voltage wire (e.g., about 40-100 micron diameter with about 2-25 kvolts or about 3-10 kvolts) or pin electrode (e.g., coronode) positioned above the media sheet to carry voltage at least high enough to generate a breakdown in electrohydrodynamic effect and establish an electric field. In particular, the corona wire 90 creates an electric field that ionizes the air, allowing it to attract and move vapor particles. A bipolar plasma region 98 established around the corona wire 90 generates both positive and negative ions, followed by a unipolar ion drift region 100 due to the electric field between the wire and the curved baffle 32. As ions move toward the oppositely charged electrode (e.g., conductive curved baffle 32), they collide with air molecules. These collisions transfer momentum to the air, creating a localized airflow 102.

Accordingly, the ionic drift generates an induced corona airflow 102 towards the media sheets due to the electrohydrodynamic effect. Forced convection via the hot air flow from the hot air supply and air knife 30 along direction arrows 38 around the curved baffle 32 (Coanda effect) causes solvent evaporation. The corona wire also disturbs the top layer of the media sheet and accelerates evaporation. The induced corona airflow 102 disturbs the boundary layer on the media sheet surface and then turns away from the media for the removal of the undesired substance (e.g., evaporated ink water, vapor, solvent)from the media.

While not being limited to a particular theory, the corona wind module 86 is one example of an electric field generating ink drying apparatus 56 that establishes an electric field to create an induced airflow 102 adjacent media sheets 12 to help accelerate moisture evaporation. Other electric field generators may be available to establish an electric field and induce airflow above a curved baffle to help remove vapor and solvents adjacent media, as understood by a skilled artisan. Some examples may include electrohydrodynamic (EHD) fans and devices, ionizers that induce airflow through ion wind, and electrostatic precipitators. It is also understood that the upper air flow device 48, upper cold air flow device 74 and corona wind module 86 are examples of airflow producing members, and that other types of airflow producing members may be included within the scope of the examples, including fans or other airflow systems that can direct airflow over the baffles. In addition, the media sheet transport system 10 may be located within a printer or other housing that includes an airflow system as discussed herein. Such printer or other housing may also include an air conditioning unit or dehumidifier as exemplary airflow producing members that reduces moisture within the housing, including vapor from printed media.

Both the media sheet ink drying apparatus 56 and the media sheet cooling apparatus 60 may independently control air temperature/flow for each air flow area (e.g., under sheet vs over sheet) which may support condensation mitigation via a controller 110 in communication with the drying and cooling apparatuses. Airflow, temperature and voltage may be tunable via the controller 110 based on variables including media sheet weight, ink weight, printed media sheet moisture amount (e.g., a photo will have more ink/moisture than a page with little text or a line graph) and viscosity, printer speed, baffle radius, curvature and length, and media sheet transport speed, as understood by a skilled artisan.

It should be noted that the second transport 16 and the downstream media handling device 82 are both considered media receiving transports. For example, the second transport 16 is a media receiving transport from the first transport 14 via the ink drying apparatus 56. Further, the media handling device 82 is a media receiving transport from the second transport 16 via the cooling apparatus 60. It follows that the first transport 14 and the second transport 16 may be considered upstream media transports in examples where they are upstream a media receiving transport. Therefore, the first transport 14 is an upstream media transport to the ink drying apparatus 56 and second transport 16, and the second transport is an upstream media transport to the cooling apparatus and the media handling device 82. In examples the media receiving transports may be positioned at a height above, below or the same as the feeding transport and/or the corresponding ink drying apparatus 56 and media handling device 82, as is readily understood by a skilled artisan.

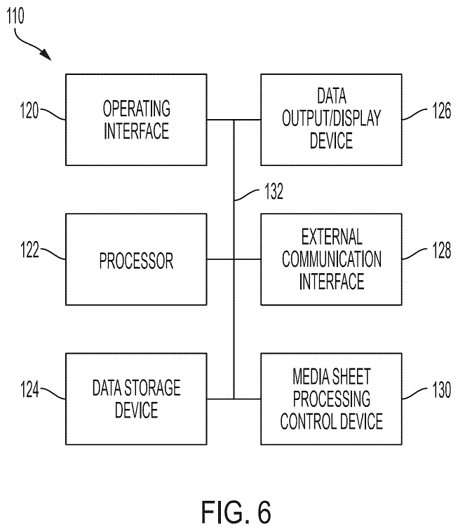

FIG. 6 illustrates a block diagram of the controller 110 for executing instructions to automatically control media sheet processing via at least the media sheet transport system 10 and components thereof. The exemplary controller 110 may provide input to or be a component of a controller for executing media sheet processing for automatically heating, cooling and transporting media sheets 12 in a system 10 such as that depicted in FIGS. 1-5, 7 and described in greater detail below.

The exemplary controller 110 may include an operating interface 120 by which a user may communicate with the exemplary control system. The operating interface 120 may be a locally-accessible user interface associated with the media sheet transport system 10. The operating interface 120 may be configured as one or more conventional mechanism common to controllers and/or computing devices that may permit a user to input information to the exemplary controller 110. The operating interface 120 may include, for example, a conventional keyboard, a touchscreen with “soft” buttons or with various components for use with a compatible stylus, a microphone by which a user may provide oral commands to the exemplary controller 110 to be “translated” by a voice recognition program, or other like device by which a user may communicate specific operating instructions to the exemplary controller. The operating interface 120 may be a part or a function of a graphical user interface (GUI) mounted on, integral to, or associated with, the media sheet transport system 10 and/or image forming system with which the exemplary controller 110 is associated.

The exemplary controller 110 may include one or more local processors 122 for individually operating the exemplary controller 110 and for carrying into effect control and operating functions for automatically heating, cooling and transporting media sheets 12 in a system 10. For example, in real-time upon receipt of media sheets 12, processors 122 may trigger a media handling apparatus to move the media sheets, a drying apparatus to heat the media sheets and dry wet marking material thereon, and a cooling apparatus to cool the media sheets for further processing. Processor(s) 122 may include at least one conventional processor or microprocessor that interprets and executes instructions to direct specific functioning of the exemplary controller 110, and control media sheet processing with the exemplary controller.

The exemplary controller 110 may include one or more data storage devices 124. Such data storage device(s) 124 may be used to store data or operating programs to be used by the exemplary controller 110, and specifically the processor(s) 122. Data storage device(s) 124 may be used to store information regarding, for example, air temperature, air flow, voltage, media sheet weight, ink weight and viscosity, printer speed, media sheet transport speed, and other media sheet processing information with which the media sheet transport system 10 is associated. Stored media sheet data may be devolved into data to generate a recurring, continuous or automated media sheet heating, cooling and transport system in the manner generally described by examples herein.

The data storage device(s) 124 may include a random access memory (RAM) or another type of dynamic storage device that is capable of storing updatable database information, and for separately storing instructions for execution of media strip processing by, for example, processor(s) 122. For example, a data storage device 124 may be coupled to the processor 122, and may include instructions which when executed by the processor, cause the hot air supply 42, air source 44, and cold air supply 76 to supply heated, cooled or ambient air flow to the drying and cooling apparatuses as needed to dry wet marking material on media sheets and cool the media sheet for further processing. Data storage device(s) 124 may also include a read-only memory (ROM), which may include a conventional ROM device or another type of static storage device that stores static information and instructions for processor(s) 122. Further, the data storage device(s) 124 may be integral to the exemplary controller 110, or may be provided external to, and in wired or wireless communication with, the exemplary controller 110, including as cloud-based data storage components.

The data storage device(s) 124 may include non-transitory machine-readable storage medium used to store the device queue manager logic persistently. While a non-transitory machine-readable storage medium is may be discussed as a single medium, the term “machine-readable storage medium” should be taken to include a single medium or multiple media (e.g., a centralized or distributed database, and/or associated caches and servers) that store one or more sets of instructions. The term “machine-readable storage medium” shall also be taken to include any medium that is capable of storing or encoding a set of instruction for execution by the controller 110 and that causes the media sheet transport system 10 to perform any one or more of the methodologies of the present invention. The term “machine-readable storage medium” shall accordingly be taken to include, but not be limited to, solid-state memories, and optical and magnetic media.

The exemplary controller 110 may include at least one data output/display device 126, which may be configured as one or more conventional mechanisms that output information to a user, including, but not limited to, a display screen on a GUI of the media sheet transport system 10 or associated image forming device with which the exemplary controller 110 may be associated. The data output/display device 126 may be used to indicate to a user a status of the media sheet transport system 10 with which the exemplary controller 110 may be associated including an operation of one or more individually controlled components at one or more of a plurality of separate media sheet processing stations or subsystems associated with the media sheet transport system, including but not limited to the media handling apparatus 26, the media sheet ink drying apparatus 56, the media sheet cooling apparatus 60, the downstream media handling device 82 and components thereof.

The exemplary controller 110 may include one or more separate external communication interfaces 128 by which the exemplary controller 110 may communicate with components that may be external to the exemplary control system such as an image forming device. At least one of the external communication interfaces 128 may be configured as an input port to support connecting an external CAD/CAM device storing modeling information for execution of the control functions in the media sheet processing operations. Any suitable data connection to provide wired or wireless communication between the exemplary controller 110 and external and/or associated components is contemplated to be encompassed by the depicted external communication interface 128.

The exemplary controller 110 may include a media sheet processing control device 130 that may be used to control media sheet processing including media sheet heating, cooling and transporting. The media sheet processing control device 130 may operate as a part or a function of the processor 122 coupled to one or more of the data storage devices 124 and the media sheet transport system 10, or may operate as a separate stand-alone component module or circuit in the exemplary controller 110.

All of the various components of the exemplary controller 110, as depicted in FIG. 6, may be connected internally, and to the media sheet transport system 10, associated media sheet processing and image forming devices upstream or downstream the media sheet transport system and/or components thereof, by one or more data/control busses 132. These data/control busses 132 may provide wired or wireless communication between the various components of the media sheet transport system 10 and any associated media sheet processing devices, whether all of those components are housed integrally in, or are otherwise external and connected to media sheet handling, processing, heating and cooling with which the exemplary controller 110 may be associated.

It should be appreciated that, although depicted in FIG. 6 as an integral unit, the various disclosed elements of the exemplary controller 110 may be arranged in any combination of sub-systems as individual components or combinations of components, integral to a single unit, or external to, and in wired or wireless communication with the single unit of the exemplary control system. In other words, no specific configuration as an integral unit or as a support unit is to be implied by the depiction in FIG. 6. Further, although depicted as individual units for ease of understanding of the details provided in this disclosure regarding the exemplary controller 110, it should be understood that the described functions of any of the individually-depicted components, and particularly each of the depicted control devices, may be undertaken, for example, by one or more processors 122 connected to, and in communication with, one or more data storage device(s) 124.

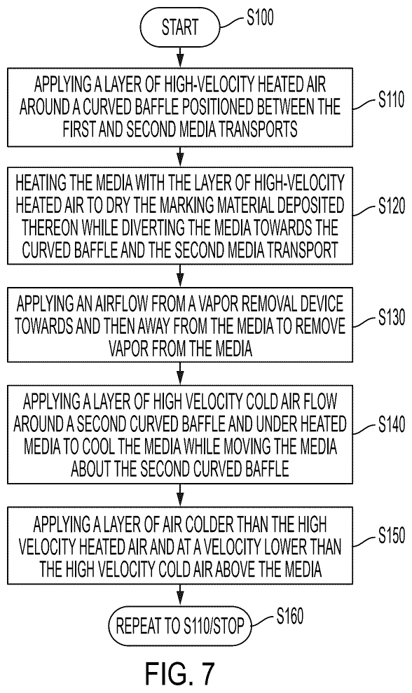

The disclosed embodiments may include an exemplary method for media sheet processing, including heating, cooling and transport thereof, and drying marking material deposited on media sheets conveyed along a paper path between first and second media transports configured for conveying the media in a media processing direction. FIG. 7 illustrates a flowchart of such an exemplary method. As shown in FIG. 7, operation of the method commences at Step S100 and proceeds to Step S110.

At Step S110, a layer of uniform high-velocity heated air is applied around a curved baffle positioned between the first and second media transports. The layer of high-velocity heated air is supplied from a lower hot air flow device positioned adjacent the curved baffle and under the paper path of the media sheets conveyed between the first and second media transports. The layer of high-velocity heated air travels around the curved baffle and under the media sheets. Operation of the method proceeds to Step S120, where media sheets are heated via the layer of high-velocity heated air to dry the marking material deposited thereon while the media sheets are diverted towards the curved baffle and the second media transport. At Step S130, an airflow from a vapor removal device is applied towards and then away from the media sheets to remove undesired substance (e.g., evaporated ink water, vapor, solvent)from above the media sheets. In examples, the vapor removal device is positioned above the paper path of the media sheets that are conveyed between the first and second media transports.

Operation may proceed to Step S140, where a second curved baffle is positioned downstream the second media transport, the paper path of the media sheets extends beyond the second media transport around the curved baffle, and a lower cold air flow device is positioned adjacent the second curved baffle and under the paper path of the media conveyed from the second media transport In Step S140, the lower cold air flow device applies a layer of uniform high velocity cold air colder that the high velocity heated air that flows around the second curved baffle and under the media to cool the media while moving the media about the second curved baffle. Operation may further proceed to Step S150, where an upper cold air flow device is positioned above the lower air flow device and above the paper path of the media conveyed from the second media transport. In Step S150, the upper cold upper air flow device applies a layer of air colder than the high velocity heated air and at a velocity lower than the high velocity cold air above the media to further cool the media. Operation may cease at Step S160, or may continue by repeating back to Step S110 for processing additional media sheets via drying wet marking material deposited thereon, and cooling the heated sheets as needed for further sheet processing.

The exemplary depicted sequence of executable method steps represents one example of a corresponding sequence of acts for implementing the functions described in the steps. The exemplary depicted steps may be executed in any reasonable order to carry into effect the objectives of the disclosed embodiments. No particular order to the disclosed steps of the method is necessarily implied by the depiction in FIG. 7, and the accompanying description, except where any particular method step is reasonably considered to be a necessary precondition to execution of any other method step. Individual method steps may be carried out in sequence or in parallel in simultaneous or near simultaneous timing. Additionally, not all of the depicted and described method steps need to be included in any particular scheme according to disclosure.

Those skilled in the art will appreciate that other embodiments of the disclosed subject matter may be practiced with many types of media, media transports and marking material common to heating, drying and cooling systems in many different configurations. It should be understood that these are non-limiting examples of the variations that may be undertaken according to the disclosed schemes. In other words, no particular limiting configuration is to be implied from the above description and the accompanying drawings.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. An apparatus for drying marking material deposited on media conveyed along a paper path in a media processing direction, comprising:
a curved baffle positioned below the paper path;
a lower air flow device positioned adjacent the curved baffle; and
wherein the lower air flow device is configured to apply a layer of high velocity air that travels around the curved baffle and under the media to dry the marking material deposited on the media while diverting the media towards the curved baffle; and
an airflow producing member configured to apply an airflow adjacent the media for removal of undesired substance from the media.

2. The apparatus of claim 1, further comprising a pre-heat station upstream the curved baffle in the media processing direction, the pre-heat station configured to heat the media prior to media conveyance to the curved baffle.

3. The apparatus of claim 1, wherein the curved baffle is positioned between first and second media transports to convey the media along the paper path in the media processing direction, and the airflow producing member including a vapor removal device positioned above the lower air flow device and above the paper path of the media conveyed between the first and second media transports, the vapor removal device configured to apply the airflow towards and then away from the media for removal of the undesired substance from the media.

4. The apparatus of claim 3, the vapor removal device including an upper air flow device and a filter collector downstream the upper air flow device in the media processing direction, the filter collector configured to collect the undesired substance from the media removed via the upper air flow device.

5. The apparatus of claim 3, wherein the curved baffle is a semi-circular curved baffle having a front side rising section adjacent the first media transport and a rear side falling section adjacent the second media transport, the curved baffle including entrance ribs at the front side rising section to provide a first boundary condition for the media conveyed from the first media transport, and exit ribs at the rear side falling section to provide a second boundary condition for the media conveyed to the second media transport.

6. The apparatus of claim 3, wherein the layer of high velocity air is high velocity heated air that travels around the curved baffle and under the media to heat the media and dry the marking material deposited thereon, the vapor removal device includes an upper air flow device configured to apply an airflow at a velocity lower than the high velocity heated air above the media for removal of the undesired substance from the media, and the airflow is a heated airflow hotter than a temperature of ambient air surrounding the airflow.

7. The apparatus of claim 3, wherein the vapor removal device includes an electric field generator having a high voltage electrode under a conductive shield opened towards the curved baffle, the electric field generator configured to establish an electric field between the curved baffle and the conductive shield and create the airflow adjacent the media.

8. The apparatus of claim 7, wherein the curved baffle is conductive, the conductive shield is grounded, and the electric field generator includes a corona wind module.

9. The apparatus of claim 1, wherein the curved baffle is positioned between first and second media transports to convey the media along the paper path in the media processing direction, and the apparatus further comprises a second curved baffle positioned downstream the second media transport, the second curved baffle having a front side rising section adjacent the second media transport and a rear side falling section downstream the front side rising section, and further including a lower cold air flow device positioned adjacent the second curved baffle and under the media conveyed from the second media transport, the lower cold air flow device configured to apply a layer of high velocity cold air colder that the high velocity air that travels around the second curved baffle and cools the media while moving the media about the second curved baffle.

10. The apparatus of claim 9, further including a cold air flow device configured to apply a layer of air colder than the high velocity air and at a velocity lower than the high velocity cold air above the media to further cool the media.

11. A method for drying marking material deposited on media conveyed along a paper path in a media processing direction, the method comprising:
a) applying a layer of high-velocity air around a curved baffle positioned below the paper path, the layer of high-velocity air supplied from a lower air flow device positioned adjacent the curved baffle, the layer of high-velocity air travelling around the curved baffle and under the media;
b) drying the marking material deposited on the media with the layer of high-velocity air while diverting the media towards the curved baffle; and
c) applying an airflow adjacent the media from an airflow producing member for removal of undesired substance from the media.

12. The method of claim 11, further comprising positioning the curved baffle between first and second media transports to convey the media along the paper path in the media processing direction, and the step of applying the airflow adjacent the media from the airflow producing member includes applying the airflow towards and then away from the media for removal of the undesired substance from the media via a vapor removal device as the airflow producing member, the vapor removal device being positioned above the lower air flow device and above the paper path of the media conveyed between the first and second media transports.

13. The method of claim 12, wherein the high velocity air is high velocity heated air supplied from the lower air flow device that heats the media to dry the marking material deposited thereon, and further comprising collecting the undesired substance from the media removed via the upper air flow device with a filter collector downstream the vapor removal device in the media processing direction.

14. The method of claim 12, further comprising, before step a), heating the media via a preheat station upstream the curved baffle in the media processing direction.

15. The method of claim 12, the vapor removal device including an upper air flow device, the method further comprising the upper air flow device applying an airflow above the media at a velocity lower than the high velocity heated air for removal of solvents including the vapor from the media, wherein the airflow is a heated airflow hotter than a temperature of ambient air surrounding the airflow.

16. The method of claim 12, the vapor removal device including an electric field generator having a high voltage electrode under a conductive shield opened towards the curved baffle, the method further comprising the electric field generator establishing an electric field between the curved baffle and the conductive shield and create the airflow adjacent the media.

17. The method of claim 12, wherein a second curved baffle is positioned downstream the second media transport, the paper path of the media extends beyond the second media transport around the curved baffle, and a lower cold air flow device is positioned adjacent the second curved baffle and under the paper path of the media conveyed from the second media transport, the method further comprising the lower cold air flow device applying a layer of high velocity cold air colder that the high velocity air that flows around the second curved baffle and under the media to cool the media while moving the media about the second curved baffle.

18. The method of claim 12, wherein an upper cold air flow device is positioned above the lower air flow device and above the paper path of the media conveyed from the second media transport, the method further comprising the upper cold upper air flow device applying a layer of air colder than the high velocity air and at a velocity lower than the high velocity air above the media to further cool the media.

19. An apparatus for drying marking material deposited on media conveyed in a paper path between first and second media transports configured for conveying the media in a media processing direction, comprising:
a curved baffle positioned between the first and second media transports;
a lower hot air flow device positioned adjacent the curved baffle and under the paper path of the media conveyed between the first and second media transports, the lower hot air flow device configured to apply a layer of high velocity heated air; and
a vapor removal device positioned above the lower hot air flow device and above the paper path of the media conveyed between the first and second media transports, the vapor removal device including an upper air flow device configured to apply an airflow at a velocity lower than the layer of high velocity heated air above the media,
the lower hot air flow device configured to apply the layer of high velocity heated air that travels around the curved baffle and under the media to heat the media and dry the marking material deposited thereon while diverting the media towards the curved baffle, and the vapor removal device configured to remove vapor from the media.

20. The apparatus of claim 19, wherein the upper air flow device includes a corona wind module having a high voltage electrode under a conductive shield opened towards the curved baffle, the corona wind module configured to establish an electric field between the curved baffle and the conductive shield and create the airflow above the media.
